(19) United States
(12) Patent Application Publication
(10) Pub. No.: US 2014/0232665 A1
(43) Pub. Date: Aug. 21, 2014

(54) ELECTRONIC APPARATUS WITH A DISPLAY MODULE INTEGRATED WITH A TOUCH SENSOR

(71) Applicant: HTC CORPORATION, Taoyuan County (TW)

(72) Inventors: Kuang-Hua Lee, Taoyuan County (TW); Te-Mu Chen, Taoyuan County (TW); Yi-Fan Hsueh, Taoyuan County (TW); Cheng-Hsi Liu, Taoyuan County (TW); Pi-Lin Lo, Taoyuan County (TW)

(73) Assignee: HTC CORPORATION, Taoyuan County (TW)

(21) Appl. No.: 13/773,617

(22) Filed: Feb. 21, 2013

(51) Int. Cl. G06F 3/041

(52) U.S. Cl. CPC G06F 3/041
USPC 345/173

(57) ABSTRACT

An electronic apparatus is provided. The electronic apparatus includes a cover glass, a display module and a mask layer. The display module is integrated with a touch sensor and is disposed under the cover glass. The display module has a display area for displaying image. The touch sensor includes a plurality of first electrodes forming a first sensing area overlapped with the display area, a plurality of second electrodes forming a second sensing area not overlapped with the display area and a plurality of third electrodes disposed under the plurality of first electrodes and the plurality of second electrodes. The mask layer is disposed between the cover glass and the second sensing area. The mask layer includes at least one non-transparent part and at least one transparent part.

### BACKGROUND DISCLOSURE

1. Field of the Disclosure

The present disclosure relates to an electronic apparatus with a display module. More particularly, the present disclosure relates to an electronic apparatus with a display module integrated with a touch sensor.

2. Description of the Related Art

At present, there are many electronic apparatuses featuring touch displays, such as smart phones, personal digital assistants, and tablet computers. A typical touch display includes a liquid crystal module (LCM) and a touch sensor. The LCM displays the graphical user interface (GUI) of the electronic apparatus. When a user operates the electronic apparatus by touching the GUI, the touch sensor can detect touch events induced by the user so that the electronic apparatus can perform functions according to the touch events.

There is a constant demand from the market for smaller, thinner and cheaper electronic apparatuses. As a result, there is an emerging trend to integrate the LCM and the touch sensor into a single module, which can effectively reduce the thickness and cost of the integrated LCM in the long run. Such integrated LCMs may be classified under two types, namely, on-cell LCMs and in-cell LCMs.

FIG. 1 is a schematic diagram showing a conventional electronic apparatus 100 with an integrated LCM 120. FIG. 2 is a cross-sectional view showing the same conventional electronic apparatus 100. The electronic apparatus 100 includes a cover glass 140, an LCM 120, a backlight 160, two touch sensors 150 and 170, and a light guide 180. The cover glass 140 includes a first part 141 and a second part 142. The first part 141 covers the LCM 120. The LCM 120 is an in-cell LCM or an on-cell LCM integrated with the touch sensor 150. In other words, the touch sensor 150 is fabricated as a part of the LCM 120. The LCM 120 serves as the touch display of the electronic apparatus 100. The backlight 160 is the light source for the LCM 120. The LCM 120 displays the GUI of the electronic apparatus 100. The touch sensor 150 detects touch events induced by the user so that the electronic apparatus 100 can perform functions according to the touch events.

The electronic apparatus 100 further includes virtual keys 131-134 for receiving the operations of the user. The virtual keys 131-134 are not mechanical keys. Instead, the virtual keys 131-134 are patterns printed on the second part 142 of the cover glass 140. The touch sensor 170 under the second part 142 is an additional touch sensor for detecting the touch events induced by the user pressing one of the virtual keys 131-134. The light guide 180 is the light source for the virtual keys 131-134.

The electronic apparatus 100 performs functions associated with the virtual keys 131-134 in response to the touch events detected by the touch sensor 170. The electronic apparatus 100 turns on when the user presses the virtual key 131. The electronic apparatus 100 displays a GUI for starting a phone call when the user presses the virtual key 132. The electronic apparatus 100 displays a GUI for sending or receiving emails when the user presses the virtual key 133. The electronic apparatus 100 becomes a digital camera when the user presses the virtual key 134.

Due to manufacturing factors such as mechanical tolerances, there is often a gap between the touch sensors 150 and 170. This gap is a touch-insensitive area undesirable to the user. The combined thickness of the touch sensor 170 and the light guide 180 is often larger than the combined thickness of the LCM 120 and the backlight 160, as shown in FIG. 2, which is also undesirable to the user.

### SUMMARY

Accordingly, the present disclosure is directed to an electronic apparatus with a display module integrated with a touch sensor. The electronic apparatus uses the sensing areas of the display module to detect touch events on both the GUI and the virtual keys. Therefore, the electronic apparatus provided by the present disclosure does not need an additional touch sensor and an additional light guide for the virtual keys, which eliminates the gap between the two touch sensors and helps to reduce the thickness of the entire electronic apparatus.

According to an embodiment of the present disclosure, an electronic apparatus is provided. The electronic apparatus includes a cover glass, a display module and a mask layer. The display module is integrated with a touch sensor and is disposed under the cover glass. The display module has a display area for displaying image. The touch sensor includes a plurality of first electrodes forming a first sensing area overlapped with the display area, a plurality of second electrodes forming a second sensing area not overlapped with the display area and a plurality of third electrodes disposed under the plurality of first electrodes and the plurality of second electrodes. The mask layer is disposed between the cover glass and the second sensing area. The mask layer includes at least one non-transparent part and at least one transparent part.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram showing a conventional electronic apparatus with an LCM.

FIG. 2 is a cross-sectional view showing a conventional electronic apparatus with an LCM.

FIG. 3, FIG. 4, FIG. 5, FIG. 6 and FIG. 7 are schematic diagrams showing electronic apparatuses according to various embodiments of the present disclosure.

FIG. 8 is a schematic diagram showing a touch sensor integrated in a display module according to an embodiment of the present disclosure.

FIG. 9, FIG. 10 and FIG. 11 are schematic diagrams showing electronic apparatuses according to some embodiments of the present disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

FIG. 3 is a schematic diagram showing an electronic apparatuses 300 according to an embodiment of the present disclosure. The electronic apparatus 300 includes a cover glass 310, a display module 330 integrated with a touch sensor 320, a backlight module 340, a sensing circuitry 350, a processor 360, and a driving circuitry 370. The cover glass 310 is disposed over the display module 330. The backlight module 340 is disposed under the display module 330. The sensing circuitry 350 is coupled to the touch sensor 320. The driving circuitry 370 is coupled to the display module 330 and the backlight module 340. The processor 360 is coupled to the sensing circuitry 350 and the driving circuitry 370.

The driving circuitry 370 drives the display module 330 to display a GUI of the electronic apparatus 300. The display module 330 comprises a first part 331 and a second part 332. Since the two parts 331 and 332 belong to the same LCM, there is substantially no gap between the first part 331 and the second part 332 of the display module 330. The touch sensor 320 spans both the first part 331 and the second part 332 of the display module 330. The first part 331 of the display module 330 displays the GUI of the electronic apparatus 300. The backlight module 340 is the light source for the display module 330. Whether the backlight module 340 is turned on or turned off is controlled by the driving circuitry 370. The sensing circuitry 350 detects one or more touch events on the touch sensor 320 induced by the operation of the user. The processor 360 provides the image data for displaying the GUI. In addition, the processor 360 performs one or more functions of the electronic apparatus 300 according to the one or more touch events detected by the sensing circuitry 350. The display module 330 may be an LCM. Moreover, the display module 330 may be an on-cell LCM or an in-cell LCM.

FIG. 4 is a schematic diagram showing an electronic apparatuses 400 according to an embodiment of the present disclosure. In the electronic apparatus 400, the cover glass 310 includes a first part 311 and a second part 312. The first part 331 of the display module 330 is disposed under the first part 311 of the cover glass 310 and the second part 332 of the display module 330 is disposed under the second part 312 of the cover glass 310. The first part 311 of the cover glass 310 is transparent. One or more patterns are printed on the second part 312 of the cover glass 310.

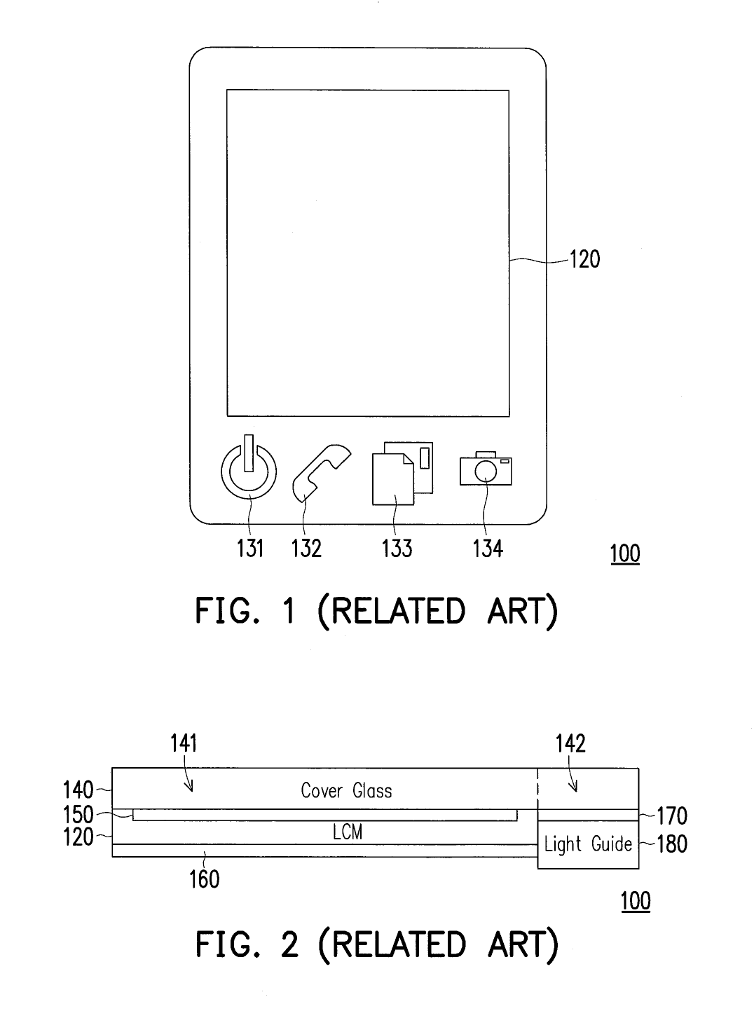

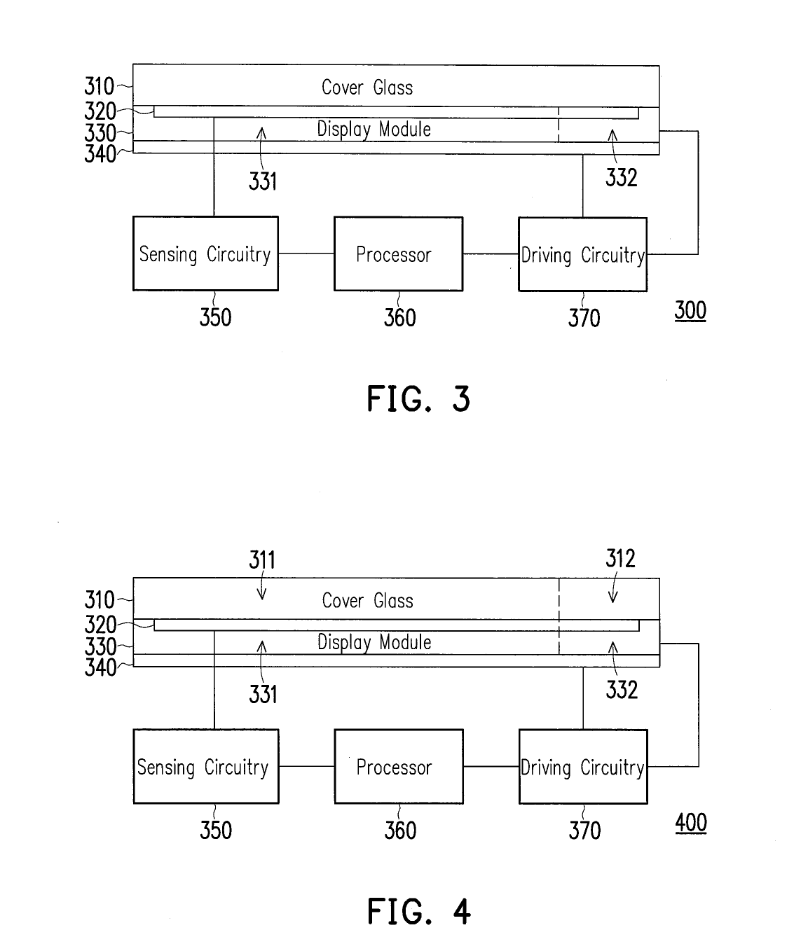

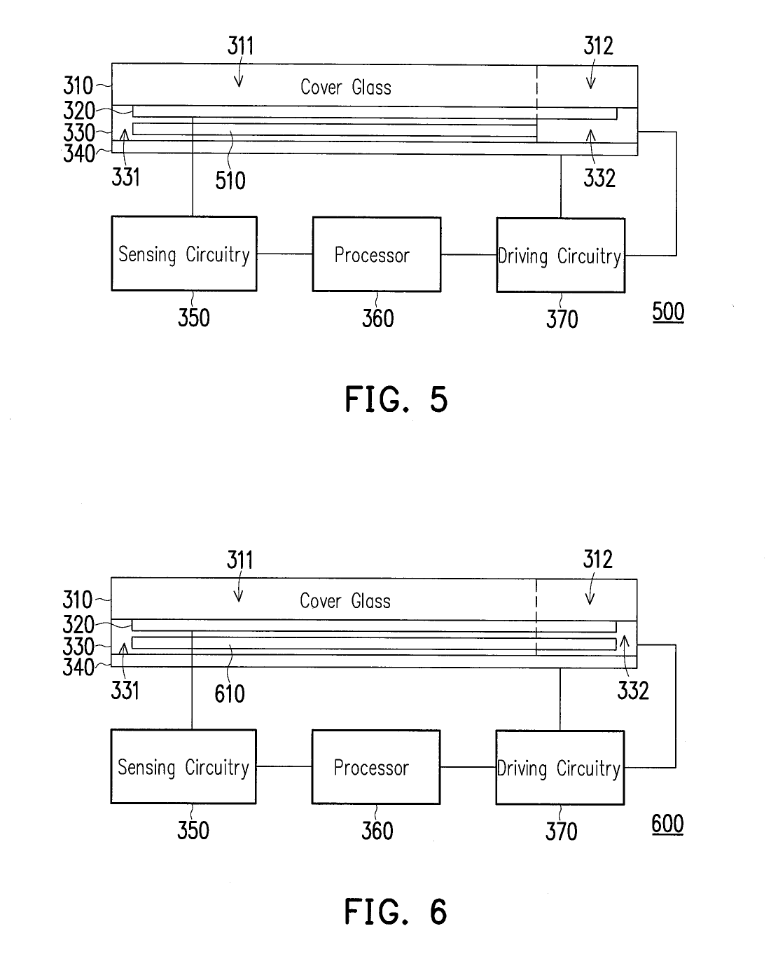

The patterns may be virtual keys such as the virtual keys 131-134 shown in FIG. 1. The patterns may be transparent and the other area of the second part 312 of the cover glass 310 may be non-transparent. When the sensing circuitry 350 detects a touch event on one of the patterns, the processor 360 may perform a function associated with that pattern.

The present disclosure is not limited to the patterns shown in FIG. 1. Other patterns may be printed on the second part 312 of the cover glass 310. In addition to virtual keys, the patterns may include other control elements for receiving the operation of the user such as sliding bars or scroll bars.

The display module 330 is the light source for the patterns so that the user can see the patterns in a dark environment. The driving circuitry 370 may drives the second part 332 of the display module 330 to display only one single color so that the patterns have a unified color. Alternatively, the driving circuitry 370 may drive the second part 332 of the display module 330 to display a temporal sequence of colors to produce a neon effect around the patterns.

In another embodiment of the present disclosure, the patterns are displayed by the display module 330 instead of being printed on the cover glass 310. The driving circuitry 370 may drive the second part 332 of the display module 330 to display one or more patterns such as virtual keys, sliding bars and/or scroll bars. When the sensing circuitry 350 detects a touch event on one of the patterns, the processor 360 may perform a function associated with that pattern.

The patterns displayed in the second part 332 of the display module 330 may be simpler than the GUI displayed by the first part 331 of the display module 330. Therefore, the display resolution of the second part 332 of the display module 330 may be lower than that of the first part 331 of the display module 330 in order to lower the cost of the display module 330.

FIG. 5 is a schematic diagram showing an electronic apparatuses 500 according to an embodiment of the present disclosure. In this embodiment, the patterns are printed on the second part 312 of the cover glass 310. The display module 330 includes a liquid crystal layer 510 spanning only the first part 331 of the display module 330. The second part 332 of the display module 330 does not comprise any liquid crystal. Therefore, the second part 332 of the display module 330 simply let the light from the backlight module 340 pass through without rotating the plane of polarization of the light. The color of the patterns on the second part 312 of the cover glass 310 is determined by the color filter of the second part 332 of the display module 330.

FIG. 6 is a schematic diagram showing an electronic apparatuses 600 according to an embodiment of the present disclosure. In this embodiment, the patterns are also printed on the second part 312 of the cover glass 310. The display module 330 includes a liquid crystal layer 610 spanning both the first part 331 and the second part 332 of the display module 330. The driving circuitry 370 controls the liquid crystal layer 610 in the first part 331 of the display module 330 to display the GUI of the electronic apparatus 600. The driving circuitry 370 does not control the liquid crystal layer 610 in the second part 332 of the display module 330. Therefore, the second part 332 of the display module 330 simply let the light from the backlight module 340 pass through without rotating the plane of polarization of the light. The color of the patterns on the second part 312 of the cover glass 310 is determined by the color filter of the second part 332 of the display module 330.

FIG. 7 is a schematic diagram showing an electronic apparatuses 700 according to an embodiment of the present disclosure. In this embodiment, the backlight module 340 includes a first part 341 and a second part 342. Both the first part 341 and the second part 342 of the backlight module 340 are coupled to the driving circuitry 370. The first part 341 of the backlight module 340 is disposed under the first part 331 of the display module 330, while the second part 342 of the backlight module 340 is disposed under the second part 332 of the display module 330. Whether the first part 341 of the backlight module 340 is turned on or turned off and whether the second part 342 of the backlight module 340 is turned on or turned off may be controlled separately by the driving circuitry 370. The backlight module 340 including the two parts 341 and 342 may replace the backlight module 340 in each previous embodiment of the present disclosure.

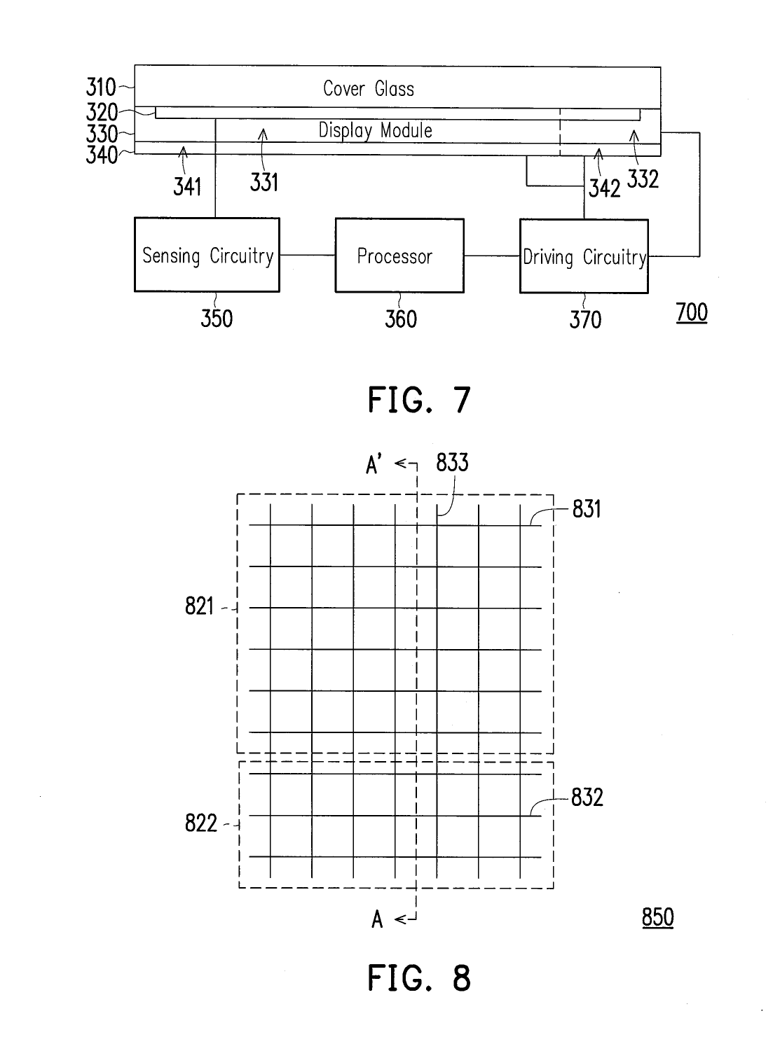

FIG. 8 is a schematic diagram showing a top view of a touch sensor integrated in a display module 850 according to an embodiment of the present disclosure. The touch sensor includes a plurality of first electrodes 831 forming a first sensing area 821, a plurality of second electrodes 832 forming a second sensing area 822, and a plurality of third electrodes 833 disposed under the plurality of first electrodes 831 and the plurality of second electrodes 832.

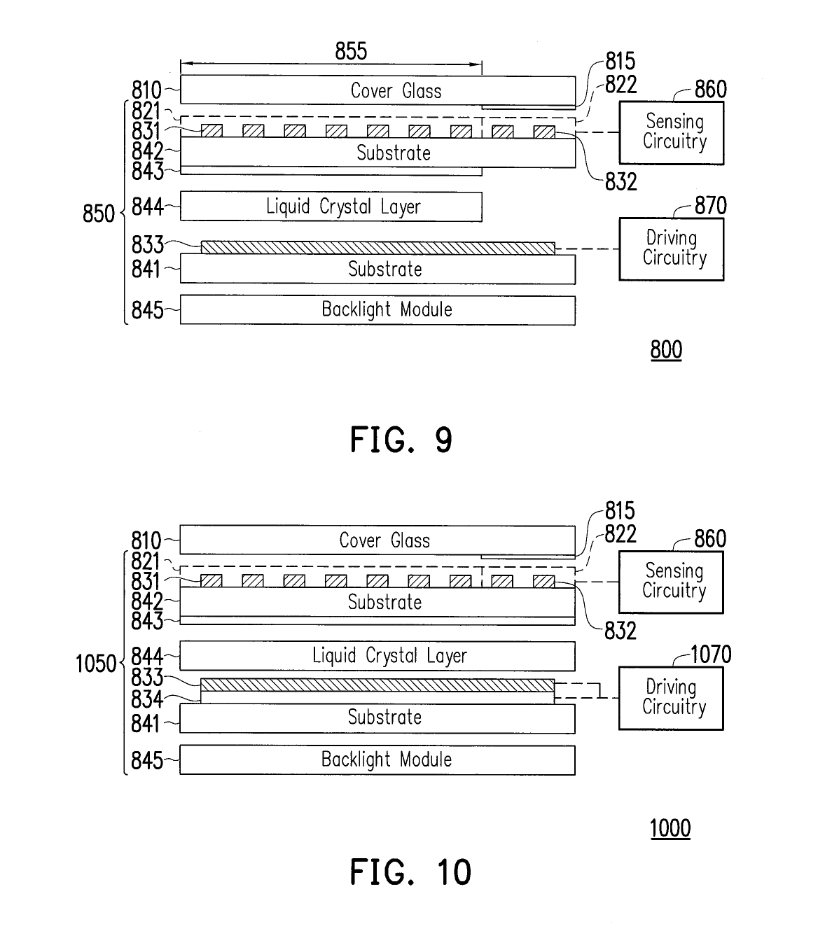

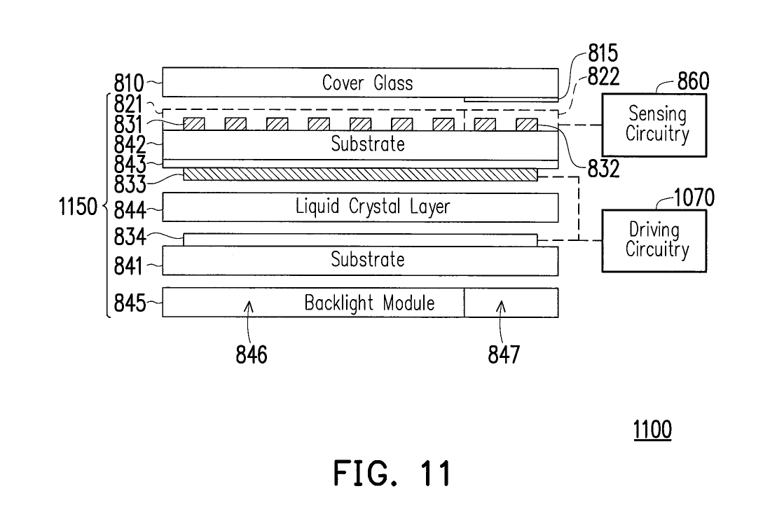

FIG. 9 is a schematic diagram showing an electronic apparatus 800 according to an embodiment of the present disclosure. The electronic apparatus 800 includes a cover glass 810, a display module 850, and a mask layer 815. The display module 850 in FIG. 9 is shown as a cross-sectional view of the AA′ line in FIG. 8. In this embodiment, the display module 850 is an in-cell display module.

The display module 850 is integrated with the aforementioned touch sensor and is disposed under the cover glass 810. The display module 850 has a display area 855 for displaying image. The first sensing area 821 overlaps with the display area 855. The second sensing area 822 does not overlap with the display area 855. The plurality of third electrodes 833 is disposed under the plurality of first electrodes 831 and the plurality of second electrodes 832.

The mask layer 815 is disposed between the cover glass 810 and the second sensing area 822. The mask layer 815 may include at least one non-transparent part and at least one transparent part. The at least one transparent part and the at least one non-transparent part of the mask layer 815 may form one or more patterns, such as the patterns 131-134 in FIG. 1.

The display module 850 further includes two substrates 841 and 842, a color filter 843, a liquid crystal layer 844, and a backlight module 845. The second substrate 842 is opposed to the first substrate 841. The color filter 843 is disposed under the sensing area 821 between the second substrate 842 and the liquid crystal layer 844. The liquid crystal layer is disposed under the sensing area 821 between the substrates 841 and 842. The backlight module 845 is disposed under the first substrate 841. The backlight module 845 generates the light transmitted through the sensing area 821 and the transparent part of the mask layer 815.

The plurality of first electrodes 831 and the plurality of second electrodes 832 are disposed between the second substrate 842 and the cover glass 810. The plurality of third electrodes 833 is disposed on the first substrate 841. From another point of view, the plurality of third electrodes 833 is disposed between the liquid crystal layer 844 and the first substrate 841.

Although the density of the electrodes 831, 832 and 833 is uniform in FIG. 8, the density of the electrodes 831, 832 and 833 may be non-uniform in other embodiments of the present disclosure. For example, the plurality of first electrodes 831 may have a higher density than that of the plurality of second electrodes 832. The plurality of third electrodes 833 under the first sensing area 821 may have a higher density than that of the plurality of third electrodes 833 under the second sensing area 822.

The electronic apparatus 800 further includes a driving circuitry 870 and a sensing circuitry 860. The driving circuitry 870 is coupled to the plurality of third electrodes 833. The plurality of third electrodes 833 is used both for detecting touch events and for driving the liquid crystal layer 844. The driving circuitry 870 transmits a touch driving signal to drive the plurality of third electrodes 833 to detect touch events. In addition, the driving circuitry 870 transmits a driving signal to the plurality of third electrodes 833 for driving the liquid crystal layer 844 to display image, such as the GUI of the electronic apparatus 800. The driving signal may be a common voltage for driving the liquid crystal layer 844.

The sensing circuitry 860 is coupled to the plurality of first electrodes 831 and the plurality of second electrodes 832. The sensing circuitry 860 is configured to receive a sense signal from the plurality of first electrodes 831 and the plurality of second electrodes 832 for detecting touch events when the plurality of third electrodes 833 is driven by the touch driving signal.

FIG. 10 is a schematic diagram showing an electronic apparatus 1000 according to another embodiment of the present disclosure. The electronic apparatus 1000 includes the cover glass 810, the mask layer 815, a display module 1050, the sensing circuitry 860, and a driving circuitry 1070.

The electronic apparatus 1000 is similar to the electronic apparatus 800. A difference between the electronic apparatuses 1000 and 800 is that the color filter 843 of the display module 1050 is disposed under both the first sensing area 821 and the second sensing area 822 between the second substrate 842 and the liquid crystal layer 844. Another difference between the electronic apparatuses 1000 and 800 is that the liquid crystal layer 844 of the display module 1050 is disposed under both the first sensing area 821 and the second sensing area 822 between the first substrate 841 and the second substrate 842.

In this embodiment, the display module 1050 is an in-cell display module. Another difference between the electronic apparatuses 1000 and 800 is that the display module 1050 further includes a plurality of fourth electrodes 834 disposed between the plurality of third electrodes 833 and the first substrate 841. Another difference between the electronic apparatuses 1000 and 800 is that the driving circuitry 870 is replaced with the driving circuitry 1070. The driving circuitry 1070 is coupled to the plurality of third electrodes 833 and the plurality of fourth electrodes 834. The driving circuitry 1070 transmits a touch driving signal to drive the plurality of third electrodes 833. The driving circuitry 1070 also transmits a driving signal to the plurality of fourth electrodes 834 for driving the liquid crystal layer 844.

FIG. 11 is a schematic diagram showing an electronic apparatus 1100 according to another embodiment of the present disclosure. The electronic apparatus 1100 includes the cover glass 810, the mask layer 815, a display module 1150, the sensing circuitry 860, and the driving circuitry 1070. The electronic apparatus 1100 is similar to the electronic apparatus 1000. A difference between the electronic apparatuses 1100 and 1000 is that the plurality of third electrodes 833 in the display module 1150 is disposed between the liquid crystal layer 844 and the second substrate 842. Another difference between the electronic apparatuses 1100 and 1000 is that the plurality of fourth electrodes 834 in the display module 1150 is disposed between the first substrate 841 and the liquid crystal layer 844. The display module 1150 is an on-cell display module.

Another difference between the electronic apparatuses 1100 and 1000 is that the backlight module 845 in the display module 1150 further includes a first part 846 and a second part 847. The first part 846 of the backlight module 845 is disposed under the first sensing area 821, while the second part 847 of the backlight module 845 is disposed under the second sensing area 822. The first part 846 and the second part 847 of the backlight module 845 are controlled independently.

In some embodiments of the present disclosure, the backlight module 845 of the electronic apparatus 1100 may be replaced by the backlight module 845 of the electronic apparatus 800 or 1000. Alternatively, in some embodiments of the present disclosure, the backlight module 845 of the electronic apparatus 1100 may replace the backlight module 845 of the electronic apparatus 800 or 1000.

In some embodiments of the present disclosure, the color filter 843 and the liquid crystal layer 844 of the electronic apparatus 800 may be replaced by the color filter 843 and the liquid crystal layer 844 of the electronic apparatus 1000 or 1100. Alternatively, in some embodiments of the present disclosure, the color filter 843 and the liquid crystal layer 844 of the electronic apparatus 800 may replace the color filter 843 and the liquid crystal layer 844 of the electronic apparatus 1000 or 1100.

In summary, the electronic apparatus provided by the present disclosure uses the touch sensor of the display module to detect touch events on both the GUI and the patterns printed on the cover glass or displayed by the display module. Therefore, the electronic apparatus provided by the present disclosure does not need an additional touch sensor and an additional light guide for the conventional virtual keys, which eliminates the gap between the two touch sensors and helps to reduce the thickness of the entire electronic apparatus.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An electronic apparatus, comprising:
a cover glass;
a display module integrated with a touch sensor and disposed under the cover glass, wherein the display module has a display area for displaying image and the touch sensor comprises a plurality of first electrodes forming a first sensing area overlapped with the display area, a plurality of second electrodes forming a second sensing area not overlapped with the display area and a plurality of third electrodes disposed under the plurality of first electrodes and the plurality of second electrodes;
a mask layer disposed between the cover glass and the second sensing area, wherein the mask layer comprises at least one non-transparent part and at least one transparent part.

2. The electronic apparatus of claim 1, wherein the display module is an on-cell display module or an in-cell display module.

3. The electronic apparatus of claim 1, wherein the display module comprises:
a first substrate;
a second substrate opposed to the first substrate;
a liquid crystal layer disposed between the first substrate and the second substrate; and
a backlight module disposed under the first substrate, wherein the plurality of first electrodes and the plurality of second electrodes are disposed between the second substrate and the cover glass, wherein the plurality of third electrodes is disposed on the first substrate.

4. The electronic apparatus of claim 3, wherein the display module further comprises a color filter disposed under the first sensing area between the second substrate and the liquid crystal layer.

5. The electronic apparatus of claim 3, wherein the display module further comprises a color filter disposed under the first sensing area and the second sensing area between the second substrate and the liquid crystal layer.

6. The electronic apparatus of claim 3, wherein the liquid crystal layer is disposed under the first sensing area between the first substrate and the second substrate.

7. The electronic apparatus of claim 3, wherein the liquid crystal layer is disposed under the first sensing area and the second sensing area between the first substrate and the second substrate.

8. The electronic apparatus of claim 3, wherein the backlight module generates a light transmitted through the first sensing area and the transparent part of the mask layer.

9. The electronic apparatus of claim 3, wherein the plurality of third electrodes is disposed between the liquid crystal layer and the first substrate.

10. The electronic apparatus of claim 9, further comprising:
a driving circuitry, coupled to the plurality of third electrodes, transmitting a touch driving signal to drive the plurality of third electrodes or transmitting a driving signal to the plurality of third electrodes for driving the liquid crystal layer; and
a sensing circuitry, coupled to the plurality of first electrodes and the plurality of second electrodes, configured to receive a sense signal from the plurality of first electrodes and the plurality of second electrodes when the plurality of third electrodes is driven by the touch driving signal.

11. The electronic apparatus of claim 10, wherein the driving signal is a common voltage for driving the liquid crystal layer.

12. The electronic apparatus of claim 9, wherein further comprising:
a driving circuitry, coupled to the plurality of third electrodes and a plurality of fourth electrodes disposed between the plurality of third electrodes and the first substrate, transmitting a touch driving signal to drive the plurality of third electrodes and transmitting a driving signal to the plurality of fourth electrodes for driving the liquid crystal layer; and
a sensing circuitry, coupled to the plurality of first electrodes and the plurality of second electrodes and configured to receive a sense signal from the plurality of first electrodes and the plurality of second electrodes when the plurality of third electrodes is driven by the touch driving signal.

13. The electronic apparatus of claim 3, wherein the plurality of third electrodes is disposed between the liquid crystal layer and the second substrate.

14. The electronic apparatus of claim 13, further comprising:
a driving circuitry, coupled to the plurality of third electrodes and a plurality of fourth electrodes disposed between the first substrate and the liquid crystal layer, transmitting a touch driving signal to drive the plurality of third electrodes and transmitting a driving signal to the plurality of fourth electrodes for driving the liquid crystal layer; and
a sensing circuitry, coupled to the plurality of first electrodes and the plurality of second electrodes and configured to receive a sense signal from the plurality of first electrodes and the plurality of second electrodes when the plurality of third electrodes is driven by the touch driving signal.

15. The electronic apparatus of claim 3, wherein the backlight module further comprises a first part and a second part and the first part of the backlight module is disposed under the first sensing area and the second part of the backlight module is disposed under the second sensing area and the first part and the second part of the backlight module are controlled independently.

16. The electronic apparatus of claim 1, wherein the transparent part and the non-transparent part of the mask layer form a pattern.

17. The electronic apparatus of claim 1, wherein the plurality of first electrodes has a higher density than that of the plurality of second electrodes.

18. The electronic apparatus of claim 1, wherein the plurality of third electrodes under the first sensing area has a higher density than that of the plurality of third electrodes under the second sensing area.
